(19) United States
(12) Patent Application Publication
(10) Pub. No.: US 2026/0014781 A1
(43) Pub. Date: Jan. 15, 2026

(54) MULTIFUNCTIONAL FABRIC FOR GARMENTS

(71) Applicant: KING SAUD UNIVERSITY, RIYADH (SA)

(72) Inventors: IBRAHIM ABDULLAH ALNASER, RIYADH (SA); MOHAMMAD REZAUL KARIM, RIYADH (SA); MUHAMMAD OMER AIJAZ, RIYADH (SA)

(21) Appl. No.: 18/768,574

(22) Filed: Jul. 10, 2024

(51) Int. Cl. B32B 27/08; B32B 27/20; B32B 27/36

(52) U.S. Cl. CPC B32B 27/08; B32B 5/266; B32B 27/20; B32B 27/36; B32B 2250/03; B32B 2250/24; B32B 2260/025; B32B 2260/046; B32B 2264/1021; B32B 2264/1051; B32B 2264/30; B32B 2307/416; B32B 2307/7145; B32B 2307/728; B32B 2437/00

(57) ABSTRACT

The multifunctional fabric for garments is a fabric for making protective garments. The multifunctional fabric includes first, second and third layers. The first layer is an outer layer and is formed from a superhydrophobic polymer, such as polylactic acid, with ultraviolet-reflective nanoparticles embedded therein. The second layer is a middle layer and is formed from a first superhydrophilic polymer with silver nanoparticles embedded therein. The third layer, which is an inner layer, is formed from a second superhydrophilic polymer with silver nanoparticles embedded therein. The second layer is sandwiched between the first and third layers, and each of the first, second and third layers is porous to make the fabric breathable. The first and second superhydrophilic polymers allow for absorption of perspiration and the silver nanoparticles embedded therein provide antimicrobial neutralization of any odors caused by the absorbed perspiration, and further serve to reflect infrared radiation from the external environment.

### BACKGROUND

### Field

The disclosure of the present patent application relates to fabrics, and particularly to a multifunctional fabric for garments providing protection against microbial growth, ultraviolet radiation and liquids from the external environment. In general, achieving multifunctional textiles requires the use of multiple materials and binders. However, this study proposes a simple approach utilizing a single core polymer. By utilizing its glass transition temperature, multiple functional layers can be easily bound together, eliminating the need for additional binding agents

### Description of Related Art

Although a wide variety of protective garments are available, such garments typically only provide a single type of protection or property. For example, waterproof garments typically do not also provide antimicrobial and ultraviolet protection. Such garments are also typically not made from breathable fabrics. As another example, fabrics designed to wick moisture from a wearer's body are not typically simultaneously waterproof, providing protection from, for example, rain.

In a wide variety of fields, ranging from outdoor workers to soldiers, garments which offer protection from a variety of environmental hazards, as well as being comfortable, are required. Rather than wearing multiple layers of clothing, where each offers a different type of protection, a single fabric with multiple benefits would allow for greater mobility and comfort for the wearer. Thus, a multifunctional fabric for garments solving the aforementioned problems is desired.

### SUMMARY

The multifunctional fabric for garments is a fabric for making protective garments, such as, but not limited to, hats, undergarments, shirts, jackets, adult diapers, military uniforms, tactical garments and the like. The multifunctional fabric includes first, second and third layers. The first layer is an outer layer and is formed from a superhydrophobic polymer, such as polylactic acid, with silica (i.e., silicon dioxide) nanoparticles embedded therein. The second layer is a middle layer and is formed from a first superhydrophilic polymer with silver nanoparticles embedded therein. The third layer, which is an inner layer, is formed from a second superhydrophilic polymer with silver nanoparticles embedded therein. The second layer is sandwiched between the first and third layers, and each of the first, second and third layers is porous to make the fabric breathable.

The superhydrophobic polymer and the embedded fumed silica nanoparticles of the first outer layer prevent absorption of liquids from the external environment and may provide a protective barrier against certain chemical and/or biological agents. Additionally, the silica nanoparticles are reflective to ultraviolet radiation, thus providing protection for the wearer's skin from ultraviolet exposure. Alternatively, or in addition to the silica nanoparticles, the nanoparticles embedded in the first layer may be titanium oxide nanoparticles, zinc oxide nanoparticles or a combination thereof. The pores formed through the first, second and third layers are sized to allow the flow of air but are small enough to prevent the passage of liquid therethrough.

The first and second superhydrophilic polymers of the second and third layers, respectively, may be the same hydrophilic polymer or may be different hydrophilic polymers. In certain embodiments, one or more of the hydrophilic polymers can be moisture-wicking hydrophilic polymers. Non-limiting examples of the moisture-wicking hydrophilic polymers include, but are not limited to, polyester and nylon. The hydrophilic nature of the polymer(s) allows for absorption of perspiration and the silver nanoparticles embedded therein provide antimicrobial neutralization of any odors caused by the absorbed perspiration. The embedded silver nanoparticles further serve to reflect infrared radiation from the external environment in order to keep the wearer cool. The silver nanoparticles may also reflect ultraviolet radiation, protecting the wearer's skin from ultraviolet exposure, and may also act to neutralize certain biological and/or chemical agents.

These and other features of the present subject matter will become readily apparent upon further review of the following specification.

### BRIEF DESCRIPTION OF DRAWINGS

FIG. 1 is a side view in section of a multifunctional fabric for garments.

FIG. 2A shows water droplet absorption testing over a period of one second for a superhydrophilic surface of the multifunctional fabric for garments.

FIG. 2B shows water droplet absorption testing over a period of 300 seconds for a superhydrophobic surface of the multifunctional fabric for garments.

FIG. 3A is a graph comparing ultraviolet (UV) and visible light reflectance for the superhydrophilic and superhydrophobic surfaces of the multifunctional fabric for garments.

FIG. 3B is a graph comparing ultraviolet (UV) and visible light absorption for the superhydrophilic and superhydrophobic surfaces of the multifunctional fabric for garments.

Similar reference characters denote corresponding features consistently throughout the attached drawings.

### DETAILED DESCRIPTION

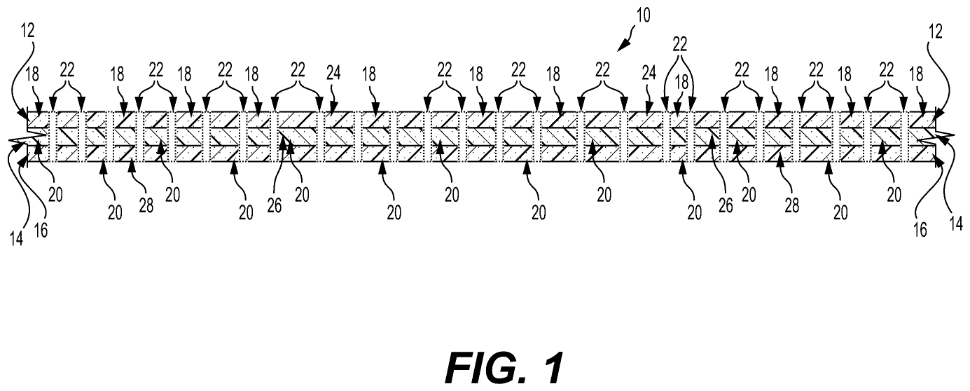

The multifunctional fabric for garments is a fabric for making protective garments, such as, but not limited to, hats, undergarments, shirts, jackets, adult diapers, military uniforms, tactical garments and the like. As shown in FIG. 1, the multifunctional fabric 10 includes first, second and third layers 12, 14, 16, respectively. It should be understood that the relative thicknesses of first, second and third layers 12, 14, 16 are exaggerated in FIG. 1 for purposes of illustration and clarity. The first layer 12 is an outer layer and is formed from a superhydrophobic polymer 24, such as polylactic acid, with fumed silica (i.e., silicon dioxide) nanoparticles 18 embedded therein. The second layer 14 is a middle layer and is formed from a first superhydrophilic polymer 26 with silver nanoparticles 20 embedded therein. The third layer 16, which is an inner layer, is formed from a second superhydrophilic polymer 28 with silver nanoparticles 20 embedded therein. The second layer 14 is sandwiched between the first and third layers 12, 16, respectively, and each of the first, second and third layers 12, 14, 16 is porous to make the fabric breathable. It should be understood that the relative diameters of pores 22 are exaggerated in FIG. 1 for purposes of illustration and clarity. It should be further understood that the distribution of pores 22 is shown for exemplary purposes only.

The superhydrophobic polymer 24 and the embedded silica nanoparticles 18 of the first outer layer 12 prevent absorption of liquids from the external environment and may provide a protective barrier against certain chemical and/or biological agents. Additionally, the silica nanoparticles 18 are reflective to ultraviolet radiation, thus providing protection for the wearer's skin from ultraviolet exposure. Alternatively, or in addition to the silica nanoparticles 18, the nanoparticles embedded in the first layer 12 may be titanium oxide nanoparticles, zinc oxide nanoparticles or a combination thereof. The pores 22 formed through the first, second and third layers 12, 14, 16 are sized to allow the flow of air but are small enough to prevent the passage of liquids therethrough.

The first and second superhydrophilic polymers 26, 28 of the second and third layers 14, 16, respectively, may be the same hydrophilic polymer or may be different hydrophilic polymers. In certain embodiments, one or more of the hydrophilic polymers can be moisture-wicking hydrophilic polymers. Non-limiting examples of moisture-wicking hydrophilic polymers which may be used include, but are not limited to, polyester and nylon. The superhydrophilic nature of the polymer(s) 26, 28 allows for absorption of perspiration from the wearer and the silver nanoparticles 20 embedded therein provide antimicrobial neutralization of any odors caused by the absorbed perspiration. The antimicrobial action may also be effective against contamination from external biological and/or chemical agents and contaminants. The embedded silver nanoparticles 20 further serve to reflect infrared radiation from the external environment in order to keep the wearer cool. The silver nanoparticles 20 may also reflect ultraviolet radiation, protecting the wearer's skin from ultraviolet exposure.

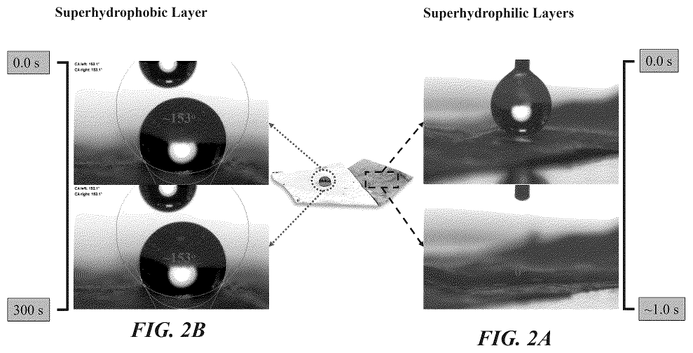

It should be understood that any suitable method may be used to form the first, second and third layers 12, 14, 16, respectively, including, but not limited to, electrospinning, melt-blowing, phase separation, template methods, fiber fibrillation, and phase separation. For purposes of testing, a non-woven sample of the multifunctional fabric 10 was prepared using electrospinning. The nanoparticles 18 in the first layer 12 were silicon dioxide nanoparticles in the samples. FIGS. 2A and 2B show the results of water droplet testing. FIG. 2A shows a water droplet placed on superhydrophilic third layer 16. The surface angle of the water droplet absorbed completely in less than a second, reaching approximately 0°, which enabled the rapid attraction of water molecules. This phenomena of superhydrophilicity layers facilitates the absorption of perspiration from the skin, thereby inhibiting bacterial proliferation. FIG. 2B shows a water droplet placed on the superhydrophobic first layer 12. Measurements of contact angle (CA) were taken at zero seconds and 300 seconds. As shown in FIG. 2B, the contact angle remained constant at 153° between zero and 300 seconds; i.e., there was no absorption of the water droplet over the entire 300 second testing period. All testing was performed at room temperature.

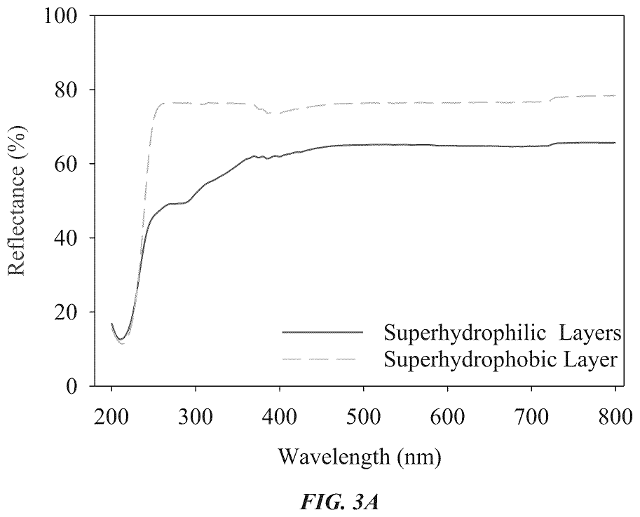

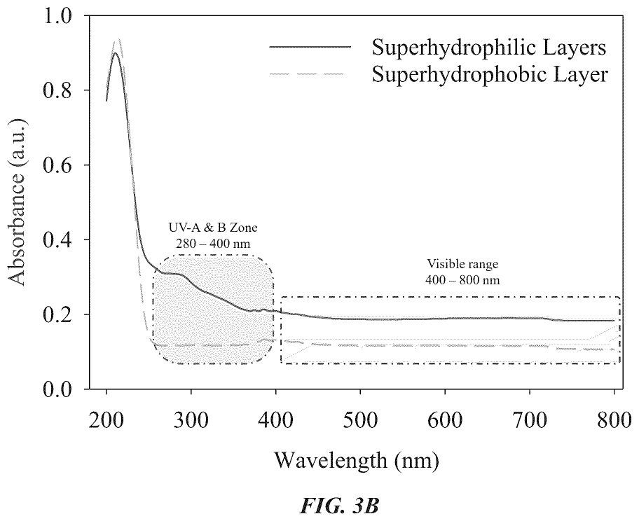

Testing was also performed for optical reflectance of absorption of ultraviolet light and visible light ranging between wavelengths from 200 nm to 800 nm. As shown in FIGS. 3A and 3B, for the first superhydrophobic layer 12, containing SiO₂ nanoparticles demonstrated excellent blockage of UV light in both zones; average reflectance of UVA radiation (315-400 nm) was about 74% and average reflectance of UVB radiation (280-315 nm) was about 76%. For the second and third layers 14, 16, with the embedded silver nanoparticles, average reflectance of UVA radiation was about 50% and average reflectance of UVB radiation was about 60%. In the visible wavelength range (400-800 nm), average reflectance of the first superhydrophobic layer 12 was about 78%, and average reflectance of the second and third layers 14, 16 was about 65%. As demonstrated by the absorbance curves in FIG. 3B, both the inner and outer sides of the fabric 10 almost completely filtered out ultraviolet light.

As shown in Table 1 below, the efficacy of first, second and third layers 12, 14, 16 at inhibiting microbial growth were also tested and compared against the antibiotic kanamycin and a blank disc, serving as a control sample. As shown in Table 1, testing was performed against Streptococcus mutans, Staphylococcus aureus, Streptococcus pneumonia, and Bacillus subtilis as Gram-positive bacterial strains. Testing was also performed against Klebsiella pneumoniae as a Gram-negative bacterial strain. The concentration of nanoparticles in each layer was 10 μg/mL. The kanamycin was also tested at a concentration of 10 μg/mL. Each microbial strain's pure colonies were selected and cultured in Mueller Hinton broth for 24 hours at 37° C. On the Mueller Hinton agar plates, 0.5 McFarland standard cultures were prepared. Freshly prepared layers 12, 14, 16 and standard kanamycin were loaded on discs and placed on the agar plates. One blank disc served as the negative control sample. After incubation for 24 hours, the zone of inhibition was measured. The experiments were carried out in triplicate.

TABLE 1
Zone of inhibition for each sample (mean ± SD, n = 3)

| | Zone of inhibition (mm) ± SD | | | | |
|---|---|---|---|---|---|
| Sample | B. subtilis | S. pneumoniae | S. aureus | S. mutans | K. pneumoniae |
| 1^{st} layer | 18.87 ± 2.63 | 19.67 ± 2.11 | 19.53 ± 2.01 | 19.17 ± 2.88 | 17.70 ± 2.11 |
| 2^{nd} layer | 17.73 ± 2.08 | 17.50 ± 0.70 | 17.87 ± 1.84 | 17.77 ± 1.05 | 18.93 ± 1.47 |
| 3^{rd} layer | 13.57 ± 0.93 | 12.30 ± 0.44 | 13.63 ± 1.80 | 12.40 ± 0.89 | 10.13 ± 1.60 |
| Kanamycin | 23.67 ± 0.91 | 23.83 ± 1.50 | 25.07 ± 1.27 | 23.77 ± 0.91 | 25.93 ± 1.27 |
| Blank | 6.97 ± 0.47 | 6.80 ± 0.26 | 7.30 ± 0.36 | 7.00 ± 0.44 | 6.80 ± 0.3 |

It is to be understood that the multifunctional fabric for garments is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A multifunctional fabric for garments, comprising:
a first layer comprising polylactic acid with fumed silica nanoparticles embedded therein;
a second layer comprising a first superhydrophilic polymer with silver nanoparticles embedded therein; and
a third layer comprising a second superhydrophilic polymer with silver nanoparticles embedded therein,
wherein the second layer is sandwiched between the first and third layers therein.

2. The multifunctional fabric for garments as recited in claim 1, wherein wherein each of the first, second, and third layers is porous.

3. The multifunctional fabric for garments as recited in claim 1, wherein the first superhydrophilic polymer and the second superhydrophilic polymer are identical.

4. The multifunctional fabric for garments as recited in claim 1, wherein the first superhydrophilic polymer and the second superhydrophilic polymer are dissimilar.

5. (canceled)

6. A multifunctional fabric for garments, comprising:
a first layer comprising polylactic acid with ultraviolet-reflective nanoparticles embedded therein;
a second layer comprising a first superhydrophilic polymer with silver nanoparticles embedded therein; and
a third layer comprising a second superhydrophilic polymer with silver nanoparticles embedded therein,
wherein the second layer is sandwiched between the first and third layers.

7. The multifunctional fabric for garments as recited in claim 6, wherein wherein each of the first, second, and third layers is porous.

8. The multifunctional fabric for garments as recited in claim 6, wherein the first superhydrophilic polymer and the second superhydrophilic polymer are identical.

9. The multifunctional fabric for garments as recited in claim 6, wherein the first superhydrophilic polymer and the second superhydrophilic polymer are dissimilar.

10. (canceled)

11. The multifunctional fabric for garments as recited in claim 6, wherein the ultraviolet-reflective nanoparticles are selected from the group consisting of titanium oxide nanoparticles, zinc oxide nanoparticles, silicon oxide nanoparticles, and combinations thereof.
